(19) United States
(12) Patent Application Publication
(10) Pub. No.: US 2024/0269663 A1
(43) Pub. Date: Aug. 15, 2024

(54) A PIPETTE TIP

(71) Applicant: SPT LABTECH LTD., Hertfordshire (GB)

(72) Inventors: David Thierry GLEDHILL, Cambridgeshire (GB); Reuben Rodber PARDOE, Cambridgeshire (GB); Robert Steven LEWIS, Cambridgeshire (GB); David Gary COCHRANE, Bedfordshire (GB)

(21) Appl. No.: 18/567,463

(22) PCT Filed: Jun. 10, 2022
(86) PCT No.: PCT/GB2022/051470

§ 371 Date: Dec. 6, 2023

(30) Foreign Application Priority Data
Jun. 11, 2021 (GB) 2108404.1

(51) Int. Cl. B01L 3/02

(52) U.S. Cl. CPC B01L 3/0217; B01L 3/0275; B01L 2200/025; B01L 2200/0689

(57) ABSTRACT

There is provided a pipette for aspirating and/or dispensing liquids, comprising a pipette tip and a plunger. The pipette tip has a proximal end and a distal end defining a longitudinal axis therebetween; an aperture at the distal end, and a fluid cavity extending from the aperture at least partially towards the proximal end. The plunger is positioned inside the pipette tip, and extends at least partly between the proximal and distal ends of the pipette tip into the end portion, and is movable towards and away from the aperture to aspirate or dispense fluid from the pipette tip. The pipette tip has an end portion disposed at the distal end, having an inner wall surface extending at an angle of between 2 degrees and 5 degrees relative to the longitudinal axis, for at least 5 mm.

### FIELD OF THE INVENTION

The present invention relates to a pipette having a pipette tip and a plunger, the pipette tip having in particular an advantageous shape.

### BACKGROUND OF THE INVENTION

It is known to use a pipette to aspirate or dispense a liquid sample.

It is also known to use a pipette having a plunger disposed in a pipette tip. A typical pipette known as a “positive displacement” pipette uses this plunger to contact the sample liquid to be aspirated. The plunger is retracted to draw in sample liquid, and is extended to dispense sample liquid. Such pipettes can be used in automated machines to improve accuracy and repeatability of pipetting actions.

The inventor has identified several problems with known pipettes, which are particularly relevant at low dispense volumes.

There is a need for an improved pipette.

### SUMMARY OF THE INVENTION

A first aspect of the invention provides a pipette for aspirating and/or dispensing liquids, comprising:
a pipette tip, having:
   a proximal end and a distal end and a longitudinal axis extending therebetween;
   an aperture at the distal end,
   a fluid cavity extending from the aperture at least partially towards the proximal end;
the pipette tip comprising an end portion disposed at the distal end, having an inner wall surface extending at an angle of at most 5 degrees relative to the longitudinal axis, for at least 5 mm; and
a plunger positioned inside the pipette tip, configured to extend at least partly between the proximal and distal ends of the pipette tip into the end portion, and movable towards and away from the aperture to aspirate and/or dispense fluid from the pipette tip.

The inner wall surface may extend at an angle of between 2 degrees and 5 degrees relative to the longitudinal axis, for at least 5 mm.

The pipette tip geometry specified in the first aspect of the invention, specifically the inner wall surface extending at an angle of at most 5 degrees relative to the longitudinal axis, for at least 5 mm, provides a significantly steeper angle than the wide angle pipette tip of the known pipette referred to in the background section. This narrow angle pipette tip has several significant advantages over known pipette tip geometries.

Firstly, it enables the pipette tip to be used in an adapted way compared to known pipette tips, with what will be referred to as a “post-sample airgap”. When performing non-contact dispensing, i.e. dispensing in which the sample liquid forms one or more droplets after leaving the pipette tip, before reaching a sample container or a sample in a sample container, a liquid sample must be travelling at a high enough velocity to detach from the tip. In known pipette tips, it is difficult to achieve this velocity with small volumes, because the plunger stroke is relatively short. The inventors have identified that a way to increase the plunger stroke is to introduce a small airgap (or other gas) after the liquid sample is aspirated, i.e. to continue to withdraw the plunger after the sample has been aspirated, to draw in air. The narrow angle tip of the first aspect ensures that this airgap can be introduced in a controlled manner. In known pipette tips, the inventors have identified that this mechanism is not viable in a pipette tip having a plunger. This is because the geometry of a known pipette tip, which has a much wider pipette tip angle than the pipette of the first aspect, is such that the liquid would attach to one side of the inner wall surface of the pipette tip and/or plunger due to surface tension. This would lead to poor dispense performance in a post-sample airgap method. The narrow angle of the pipette tip of the first aspect provides a more uniform liquid attachment, so mitigates this problem.

Secondly, the inventors have identified that it enables the pipette tip to be used in a further adapted way to known pipette tips, with what will be referred to as a “pre-sample airgap”. In such a mechanism, the plunger can be initially retracted to draw in a gas, such as air, and then subsequently retracted to draw in a sample liquid.

The advantage of using a pre-sample airgap mechanism is that all of the liquid that is aspirated can be dispensed, i.e. there is no dead volume within the pipette tip. The dead volume is a gap between the plunger and pipette tip resulting from manufacturing tolerances which do not permit a perfect fit. Without the pre-sample airgap, some of the liquid sample would remain in this gap between the plunger and the tip.

The narrow angle tip also ensures the liquid sample drawn in remains as a single slug that can be fully ejected on dispensing, as opposed to sticking to one side of the inner wall surface of the pipette tip. This allows very low volumes (<200 nl) to be handled.

The tip being configured for use with a pre-sample airgap has an additional advantage. Traditional positive displacement pipettes require a minimum volume of liquid to be aspirated to prime them correctly. Dispense performance can be compromised if they are not primed correctly. The pre-sample air gap described above removes the need for a priming volume, meaning low source-volumes (<500 nl) and low dispensing volumes (<200 nl) can be handled.

Thirdly, the pipette tip geometry provides a combination of good reach and capacity. The geometry of the pipette tip allows the pipette to reach the bottom of a V-shaped well, such as a well in a PCR microplate, to extract as much liquid as possible, while having a capacity large enough to minimise the number of aspirations/dispenses required to empty or fill a well. This high capacity helps to minimise the number of loads required to perform a dispense, saving time and associated cost. The capacity of the design may be as high as 100 μl.

A further advantage of the first aspect to be noted, of this non-exhaustive list—which may be deduced from the above advantages—is that the tip geometry provides a pipette having a large dynamic range: for example, from approximately 0.1 or 0.2 μl to approximately 100 μl. The pre-sample airgap and post-sample air-gap mechanisms which are made possible by the tip geometry, as well as the overall capacity made possible by the tip geometry, provide a particularly advantageous pipette tip suitable for a variety of sample and/or source volume aspirating and/or dispensing.

The pipette may be particularly suited for use in quantitative polymerase chain reaction (“qPCR”) methods. Further optional advantageous features of the invention are set out in the following passages.

The end portion may have an outer wall surface extending at an angle of at most 5 degrees relative to the longitudinal axis, for at least 5 mm. The outer wall surface may extend at an angle of at most 4 degrees relative to the longitudinal axis, preferably at most 3.5 degrees relative to the longitudinal axis, preferably at most 3.3 degrees relative to the longitudinal axis.

The aperture may have a diameter of at most 1 mm, preferably at most 0.5 mm, further preferably at most 0.4 mm, optionally at least 0.4 mm.

The end portion may have a maximum outer diameter of at most 4 mm, preferably at most 3 mm, further preferably at most 2 mm, further preferably at most 1 mm, further preferably at most 0.7 mm, further preferably at most 0.65 mm. Optionally, the end portion 110 may have a maximum outer diameter of at least 0.5 mm, optionally at least 0.6 mm, optionally at least 0.65 mm

The inner wall surface of the end portion of the pipette tip may define a straight-sided shape, such as a frusto-conical or cylindrical shape.

The outer wall surface of the end portion of the pipette tip may define a straight-sided shape, such as a frusto-conical or cylindrical shape.

The plunger may have an end portion outer wall surface configured for alignment with the inner wall surface of the pipette tip end portion.

The plunger may be configured to seal the aperture when in an extended position.

The plunger may have an end portion which may substantially or entirely fill the end portion of the pipette tip when in an extended position. The plunger may have a plunger end portion may not substantially or entirely fill the end portion of the pipette tip when in an extended position.

The inner wall surface may extend at an angle of at most 4 degrees relative to the longitudinal axis; preferably at most 3 degrees relative to the longitudinal axis; further preferably at most 2 degrees relative to the longitudinal axis, preferably at most 1.9 degrees relative to the longitudinal axis, preferably at most 1.87 degrees relative to the longitudinal axis.

The inner wall surface of the end portion may extend for at least 7 mm, preferably at least 10 mm, further preferably at least 12 mm.

The pipette having any of the variations noted herein may be comprised in a liquid handling system, the liquid handling system also comprising an actuator configured to move the plunger relative to the pipette tip.

There may be provided a liquid handling system comprising:
a plurality of pipettes having any of the variations noted herein; and
an actuator configured to move multiple pipette tips and/or plungers of the plurality of pipettes so as to aspirate and/or dispense a fluid.

The actuator may be configured to move multiple pipette tips and/or plungers of the plurality of pipettes simultaneously so as to aspirate and/or dispense a fluid.

The plurality of pipettes may be arranged in a planar, 2D arrangement relative to one another. The plurality of pipettes may be arranged in a regular, optionally symmetrical matrix, such as a grid-like shape. The plurality of pipettes may be arranged in a square or rectangular shape.

The plurality of pipettes may be at least 10, preferably at least 100, more preferably at least 200, more preferably at least 300, more preferably 384 pipette tips. The plurality of pipettes may be arranged in a regular, optionally symmetrical matrix, such as a grid-like 16×24 matrix.

According to a second aspect of the invention, there is provided a method of aspirating a liquid comprising:
providing the pipette having any of the variations noted herein;
retracting the plunger relative to the pipette tip so as to aspirate a gas through the aperture into the pipette tip; and subsequently
retracting the plunger so as to aspirate a sample liquid through the aperture into the pipette tip.

The method may further comprise:
extending the plunger relative to the pipette tip so as to dispense a sample liquid through the aperture from the pipette tip; and subsequently
extending the plunger so as to dispense a gas through the aperture from the pipette tip.

The method may further comprise:
providing the pipette having any of the variations noted herein;
retracting the plunger so as to aspirate a liquid through the aperture into the pipette tip; and subsequently
retracting the plunger relative to the pipette tip so as to aspirate a gas through the aperture into the pipette tip.

The method may further comprise:
extending the plunger so as to dispense a gas through the aperture from the pipette tip; and subsequently
extending the plunger relative to the pipette tip so as to dispense a sample liquid through the aperture from the pipette tip.

### BRIEF DESCRIPTION OF THE DRAWINGS

Embodiments of the invention will now be described with reference to the accompanying drawings, in which:

FIG. 1 is a cross section through a pipette tip and a side view of a plunger;

FIG. 2 is a perspective view of a pipette tip and plunger in a disassembled state;

FIG. 3 is an enlarged view of the end portion of the pipette tip and an end portion of the plunger in an assembled state;

FIG. 4 is a schematic of aspirating a liquid in a wide-angle pipette tip;

FIG. 5 is a schematic of aspirating a liquid in a narrow-angle pipette tip;

FIG. 6 is a schematic of aspirating a liquid in a wide-angle pipette tip;

FIG. 7 is a schematic of aspirating a liquid in a narrow-angle pipette tip; and

FIG. 8 is a schematic of a magnetic bead clean-up process involving a narrow-angle pipette tip;

FIG. 9 is a schematic of a liquid dispensing apparatus; and

FIG. 10 is a view of part of a pipette tip.

### DETAILED DESCRIPTION OF EMBODIMENT(S)

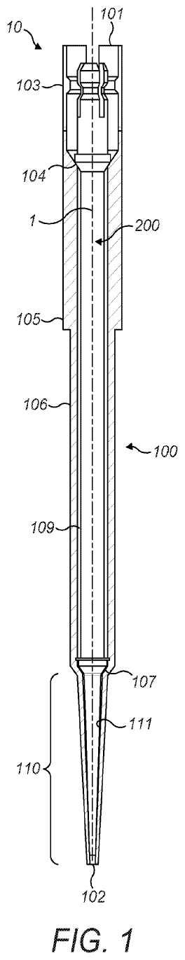

FIG. 1 shows a pipette 10 for aspirating and/or dispensing liquids. The pipette 10 comprises a pipette tip 100 and a plunger 200.

The pipette tip 100 may be a receptacle for receiving and/or containing a sample fluid, or a sample liquid. The pipette tip 100 may be configured for insertion into a container of sample liquid, or into sample liquid.

The pipette tip 100 has a proximal end 101 and a distal end 102 defining a longitudinal axis 1 therebetween.

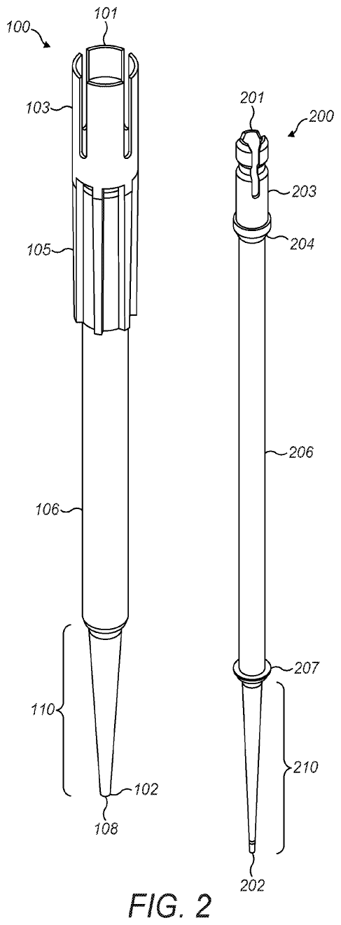

The pipette tip 100 has an aperture 108 at its distal end 102, as indicated in FIG. 2. The aperture 108 may be defined by an inner wall surface 111 of the pipette tip 100 at the distal end 102, specifically at an outermost distal point of the pipette tip 100. The aperture 108 may define a substantially circular shape or circle. The aperture 108 may have a diameter of at most 1 mm, preferably at most 0.5 mm, further preferably at most 0.4 mm. Optionally, the aperture 108 may have a diameter of at most 0.35 mm, 0.3 mm, 0.25 mm, 0.1 mm. Optionally, the aperture 108 may have a diameter of at least 0.4 mm.

The inner wall 111 of the pipette tip 100 may extend through a support portion 105 and/or a main body portion 106 of the pipette tip 100. The inner wall surface 111 may be substantially tubular and/or have parallel sides within the support portion 105 and/or main body portion 106. The pipette tip 100 has a fluid cavity 109 extending from the aperture 108 at least partially towards the proximal end 101.

The fluid cavity 109 may be configured to receive and/or retain a fluid, such as an airgap or sample liquid. The fluid cavity 109 may be substantially elongate. The fluid cavity 109 may be defined by the inner wall surface 111 of the pipette tip 100. The fluid cavity 109 may be mostly or wholly disposed within an end portion 110 of the pipette tip 100.

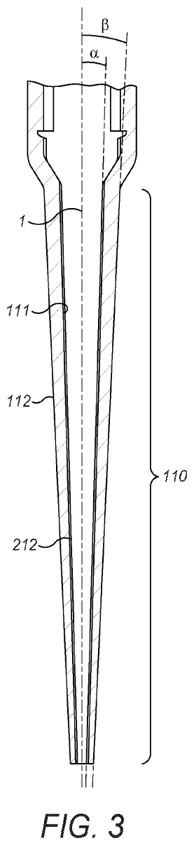

The pipette tip 100 comprises an end portion 110 disposed at the distal end 102, having an inner wall surface 111 extending at an angle α of at most 5 degrees, or π/36 radians, or approximately 0.08 to 0.09 radians, relative to the longitudinal axis 1, for at least 5 mm. The inner wall surface 111 may extend at an angle α of at most 4 degrees relative to the longitudinal axis 1; preferably at most 3 degrees relative to the longitudinal axis 1; further preferably at most 2 degrees relative to the longitudinal axis 1. The angle α may be seen in FIG. 3. The angle α may be at least 0 degrees, i.e. parallel to the longitudinal axis 1. A pipette tip end portion 110 extending at an angle of at least 2 degrees or at least 1 degree relative to the longitudinal axis 1 may be advantageous compared to an angle of 0 degrees as it may be easier, simpler and/or cheaper to manufacture. The angle α may be measured using any appropriate angle measurement technique known to the skilled person.

The longitudinal axis 1 may be a central axis about which the pipette tip 101 and/or plunger 200 is disposed. The longitudinal axis 1 may define a central axis about which the pipette tip 100 and/or plunger 200 are disposed uniformly or symmetrically. The pipette tip 100 and/or plunger 200 may be configured so that the direction of aspirating and/or dispensing is along the longitudinal axis 1.

The inner wall surface 111 of the end portion 110 may extend for at least 7 mm at an angle of at most or equal to angle α, preferably at least 10 mm at an angle of at most or equal to angle α, further preferably at least 12 mm at an angle of at most or equal to angle α. The inner wall 111 of the end portion 110 of the pipette tip 100 may define a straight-sided shape, such as a frusto-conical or cylindrical shape.

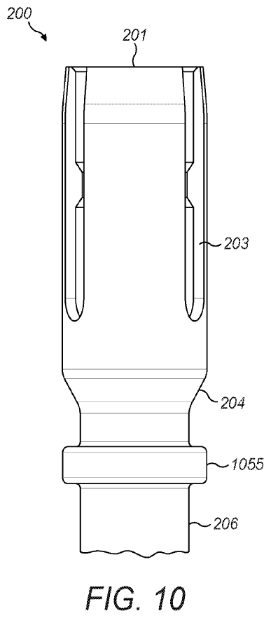

The end portion 110 may have an outer wall surface 112 extending at an angle ß, as best seen in FIG. 3, of at most 5 degrees relative to the longitudinal axis 1, for at least 5 mm. The outer wall surface 112 of the end portion of the pipette tip may define a straight-sided shape, such as a frusto-conical or cylindrical shape. The end portion 110 may have a maximum outer diameter of at most 4 mm, preferably at most 3 mm, further preferably at most 2 mm, further preferably at most 1 mm, further preferably at most 0.7 mm, further preferably at most 0.65 mm. Optionally, the end portion 110 may have a maximum outer diameter of at least 0.5 mm, optionally at least 0.6 mm, optionally at least 0.65 mm 1055, for example as shown in FIG. 10. The ring 1055 may be configured to provide a reaction force during use. The ring 1055 may be configured to position or centre the pipette tip 100 during storage and/or use. The ring 1055 may be configured to at least partly facilitate ejection of the pipette tip 100 from a moulding tool during manufacture.

The main body portion 106 may be substantially cylindrical and/or elongate. The main body portion 106 may have a substantially uniform inner diameter and/or outer diameter. The main body portion 106 may extend along at least half of the length of the pipette tip 100. The main body portion 106 may have a larger inner and/or outer diameter than any diameter of the end portion 110.

The bridging portion 107 may be configured to bridge the main body portion 106 to the end portion 110. The bridging portion 107 may define a step between the main body portion 106 and the end portion 110. The bridging portion 107 may be substantially tapered, conical and/or dome-shaped.

The plunger 200 is positioned inside the pipette tip 100. The plunger 200 may be configured to move relative to the pipette tip 100 so as to draw in a fluid into the pipette tip 100, and/or to expel a fluid from the pipette tip 100. Specifically, when moving from an extended position to a retracted position, the plunger 200 may draw fluid, such as an airgap or sample liquid, into the pipette tip 100. When moving from a retracted position to an extended position, the plunger 200 may expel fluid, such as an airgap or sample liquid, from the pipette tip 100.

The plunger 200 and/or pipette tip 100 may be configured so that in an extended position, the plunger 200 may be wholly contained within the pipette tip 100. The plunger 200 is configured to extend at least partly between the proximal and distal ends 101, 102 of the pipette tip 100 into the end portion 110. The plunger 200 may be configured to extend substantially or wholly between the proximal and distal ends 101, 102 of the pipette tip 100 into the end portion 110. The plunger 200 is movable towards and away from the aperture 109 to aspirate or dispense fluid from the pipette tip 100. The plunger 200 may have an end portion outer wall surface 212 configured for alignment with the inner wall surface 111 of the pipette tip end portion 110. The plunger 200 may comprise or consist of a polymeric material. The plunger 200 may comprise or consist of a homogeneous material.

The plunger 200 may comprise a series of portions, each having a different function, distinguishing features and/or a different shape or dimensions. The plunger 200 may comprise one or more of: a plunger connector portion 203, a centering portion 204, a main body portion 206, and a sealing portion 207, for example as shown in FIG. 1. From the proximal end 201 to the distal end 202, each portion may be arranged in the order: plunger connector portion 203, centering portion 204, main body portion 206, sealing portion 207 and end portion 210.

The plunger connector portion 203 of the plunger 200 may be configured to be received in the tip connector portion 103 of the pipette tip 100. The plunger connector portion 203 may be configured for connection to a liquid handling system. The plunger connector portion 203 may be configured as a snap-fit connection.

The centering portion 204 may be configured to be received in a centering portion 104 of the pipette tip 100, so as to centre the plunger 200 within the pipette tip 100. The centering portion 204 may be substantially conical or dome-shaped.

The main body portion 206 of the plunger 200 may be configured to be received in the main body portion 106 of the pipette tip 100. The main body portion 206 may be substantially cylindrical and/or elongate. The main body portion 206 may have a substantially uniform diameter. The main body portion 206 may extend along at least half of the length of the plunger, optionally at least two thirds of the length of the plunger 200. The main body portion 206 may have a larger diameter than the diameter of the end portion 210.

The sealing portion 207 of the plunger 200 may be configured to be received in the bridging portion 107 of the pipette tip 100. The sealing portion 207 may be configured to form a seal against an inner wall of the pipette tip 100. The sealing portion 207 may form a fluid-tight seal within the pipette tip, such that fluid cannot pass from a proximal side of the sealing portion 207 to a distal side of the sealing portion 207 when the plunger 200 is installed in the pipette tip 100. The sealing portion 207 may be at least partly flexible. The sealing portion 207 may be configured to bridge the main body portion 206 to the end portion 210. The sealing portion 207 may define a step between the main body portion 206 and the end portion 210. The sealing portion 207 may be substantially tapered, conical and/or dome-shaped.

The end portion 210 of the plunger 200 may be configured to be received in the end portion 110 of the pipette tip 100. The end portion 210 may have a smaller diameter than the sealing portion 207 and/or the main body portion 206.

The end portion 210 may substantially or entirely fill the end portion 110 of the pipette tip 100. This may be such that there is no airgap within the pipette tip end portion 110 when the plunger end portion 210 is in an extended position. The end portion 210 may contact the inner wall surface 111 of the pipette tip end portion 110 when the plunger end portion 210 is in an extended position.

The end portion 210 may be substantially elongate and/or conical. The end portion 210 may have substantially straight walls. The end portion 210 may have an outer wall 212 having a shape that complements, matches and/or corresponds to a shape of the inner wall surface 111 of the pipette tip end portion 110. The end portion 210 may have an outer wall 212 that is aligned with and/or parallel to the inner wall surface 111 of the pipette tip end portion 110, over at least part of the length of the inner wall surface 111, substantially all of, or the entire length of the inner wall surface 111.

The end portion 210 of the plunger 200 may have a substantially flat face at its distal end 202. The end portion 210 of the plunger 200 may seal the aperture 108 of the pipette tip end portion 110 when the plunger 200 is in an extended position.

Specifically, the distal end 202 of the plunger 200 may seal the aperture 108 of the pipette tip end portion 110. The end portion 210 may be configured such that the plunger distal end 202 is disposed at the pipette tip distal end 102 when the plunger 200 is in an extended position. The plunger 200 may be configured such that the plunger distal end 202 does not extend beyond the pipette tip distal end 102 when in an extended position.

The pipette 10 having any of the variations noted herein may be comprised in a liquid handling system (not shown), the liquid handling system also comprising an actuator configured to move the plunger 200 relative to the pipette tip 100.

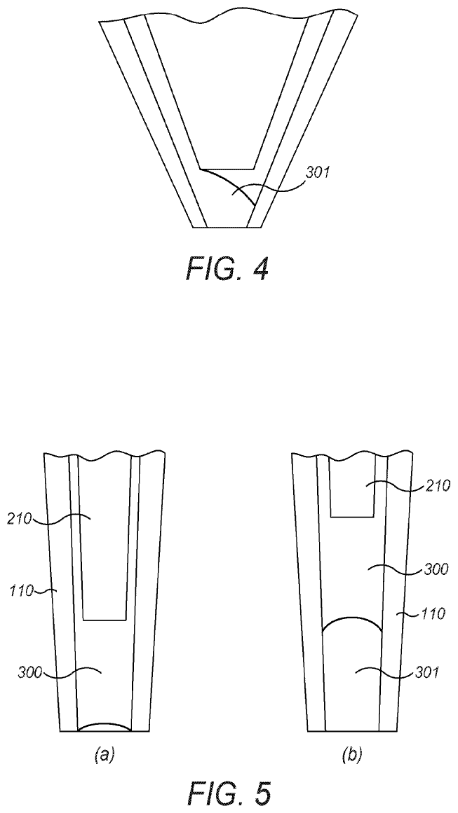

The pipette tip 100 and/or plunger 200 may be detachable and/or attachable to or from a pipetting system or apparatus. The pipette tip 100 may be detachable and/or attachable at its proximal end 101. The plunger 200 may be detachable and/or attachable at its proximal end 201. The pipette tip 100 and/or plunger may comprise a connector means or portion 103, 203, which may be disposed at the respective proximal end 101, 201, to make the pipette tip 100 or plunger 200 suitable or configured for attachment or detachment from a pipetting system or apparatus. The pipette tip 100 and/or plunger 200 may be configured so that during aspiration, sample liquid does not extend past the proximal end 101, so does not pass into a liquid handling system or apparatus. In this way, sample liquid may be contained within the removable pipette tip 100, preventing contamination of a liquid handling system or apparatus. This in turn makes the apparatus or system suitable for use with multiple different sample fluids, through use of removable and optionally disposable pipette tips 100 and/or plungers 200. Some advantages of the first aspect of the invention are demonstrated in FIGS. 4 to 8.

In FIG. 4, a known, wide-angle pipette tip is shown. The figure illustrates how in this type of pipette tip, in particular one having such a wide-angled end taper, when seeking to aspirate air into the tip after the sample the sample 301 can attach to one side on the pipette tip and detach from the other. This can result in uneven distribution of the dispensing pressure to the sample when the plunger is actuated for dispensing, resulting in degraded dispensing performance.

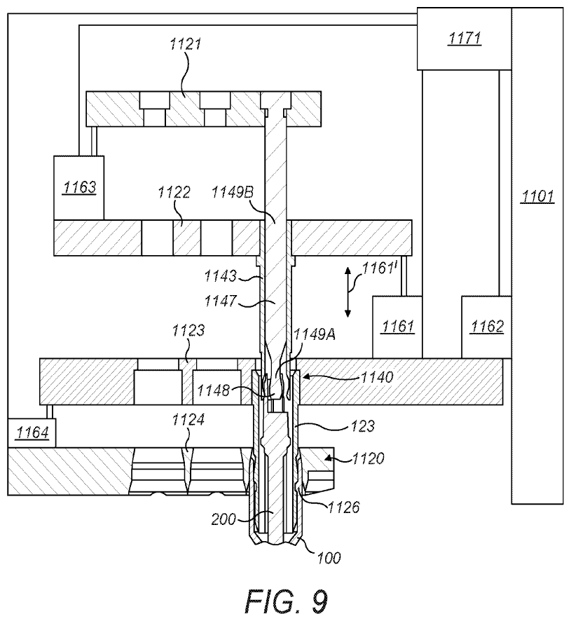

A pipette tip 100 according to the present disclosure is shown in FIG. 5. As illustrated in the Figure, the narrower angle of the end portion 110 of the pipette tip can help to avoid the asymmetrical attachment of the sample within the pipette tip shown in FIG. 4, and thus mitigates or eliminates the related negative effects. In FIG. 5, the pipette tip 100 is shown in an aspirating step with a pre-sample air gap method. In such a method, the plunger 200 can be initially retracted to draw in a gas, such as air 300, as shown in FIG. 5(a), and then subsequently retracted to draw in a sample liquid 301, as shown in FIG. 5(b). The advantage of using a pre-airgap mechanism or method is that the dead volume (sample liquid left in the pipette after dispensing) is reduced. The narrow angle pipette tip 100 ensures the liquid sample drawn in remains as a single slug 301 that can be fully ejected on dispensing. This allows very low volumes (<200 nl) to be handled. Steps in the method are described in the following passages. The steps can be implemented using an actuation mechanism such as that described in relation to FIG. 9.

The method of aspirating a liquid may include the following:
providing the pipette 10;
retracting the plunger 200 relative to the pipette tip 100 so as to aspirate a gas 300 through the aperture 108 into the pipette tip 100; and subsequently
retracting the plunger 200 so as to aspirate a sample liquid 301 through the aperture 108 into the pipette tip 100. This may be referred to as a pre-sample airgap method.

The method may further comprise:
extending the plunger 200 relative to the pipette tip 100 so as to dispense a sample liquid 301 through the aperture 108 from the pipette tip 100; and
subsequently extending the plunger 200 so as to dispense a gas 300 through the aperture 108 from the pipette tip 100.

The method may further comprise:
providing the pipette 10;
retracting the plunger 200 so as to aspirate a liquid 301 through the aperture 108 into the pipette tip 100; and subsequently
retracting the plunger 200 relative to the pipette tip 100 so as to aspirate a gas 302 through the aperture 108 into the pipette tip 100. This may be referred to as a post-sample airgap method.

The method may further comprise:
extending the plunger 200 so as to dispense a gas 302 through the aperture 108 from the pipette tip 100; and subsequently
extending the plunger 200 relative to the pipette tip 100 so as to dispense a sample liquid 301 through the aperture 108 from the pipette tip 100.

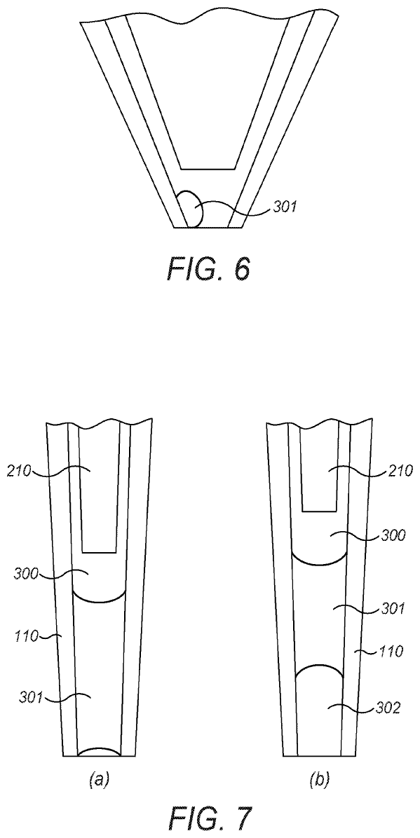

In FIG. 6, a known, wide-angle pipette tip is shown. In this pipette tip, it can be seen that when seeking to aspirate air into the pipette tip both before and after the sample, the sample 301 may attach to one side on the pipette tip and detach from the other. When performing non-contact dispensing, a liquid sample must be travelling at a high enough velocity to detach from the tip. In known pipette tips, it is difficult to achieve this velocity with small volumes, because the plunger stroke is relatively short. The inventors have identified that a way to increase the plunger stroke is to introduce a small airgap (or other gas) after the liquid sample is aspirated, i.e. to continue to withdraw the plunger after the sample has been aspirated, to draw in air. In known pipette tips, such as the pipette tip of FIG. 6, the inventors have identified that this mechanism is not viable in a pipette tip having a plunger. This is because the geometry of a known pipette tip, which has a much wider pipette tip angle than the pipette of the first aspect, is such that the liquid would attach to one side of the inner wall surface of the pipette tip and/or plunger due to surface tension. This would lead to poor dispense performance in a post-airgap mechanism.

A pipette tip 100 according to the present disclosure is shown in FIG. 7. In FIG. 7, the pipette tip 100 is shown in an aspirating step with a pre-sample air gap 300, a sample 301, and a post-sample air gap 302. The narrow angle tip of pipette tip 100 ensures that this post-sample airgap 302 can be introduced in a controlled manner. The narrow angle of the pipette tip 100 demonstrated in FIG. 7 provides a more uniform liquid attachment.

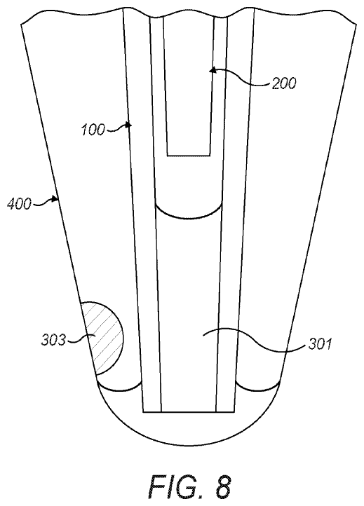

A further advantage of the pipette tip 100 of the present disclosure is that it provides a combination of good reach and capacity. This is particularly advantageous in methods involving magnetic bead clean-up, for example as demonstrated in FIG. 8. During magnetic bead clean-up, magnetic beads 303 are pulled to the side of a microplate well 400 by an external magnet. Liquid 301 is then extracted from the well 400 while the magnetic beads 303 must remain in the well 400. The geometry of the narrow angle pipette tip 100 is particularly suitable to avoid contact with magnetic beads.

The pipette 10 may be provided as a part of a liquid dispensing apparatus, which may comprise a pipetting head and/or a direct drive actuator.

The pipette tip 100 and/or plunger 200 may be configured for attachment to the apparatus by a pipette tip clamping mechanism 1120. There may be provided a plate on which multiple pipette tip clamping mechanisms 1120 are provided. The pipette tip 100 may be attached to the apparatus by a pipette tip clamping mechanism 1120, which may involve a clamp at the pipette tip connector portion 103. The plunger 200 may be attached to the apparatus by a plunger clamping mechanism 1140, which may involve a clamp at the plunger tip connector portion 203. There may be provided a plate on which multiple plunger clamping mechanisms 1140 are provided.

FIG. 9 embodiment shows an embodiment in which the pipette tip 100 and plunger 200 are attached to the apparatus via a plurality of plates 1121, 1122, 1123, 1124. The skilled person will appreciate that the apparatus and method of the present disclosure may alternatively involve other attachment components and mechanisms. The apparatus may comprise a first plate 1121, a second plate 1122, a third plate 1123 and/or a fourth plate 1124. The plunger 200 may be attached to the first and second plates 1121, 1122, which may be referred to as plunger plates. The pipette tip 100 may be attached to the third and fourth plates 1123, 1124, which may be referred to as pipette plates. The pipette tip 100 may be attached to the apparatus, specifically to the third and fourth plates 1123, 1124, by a pipette tip clamping mechanism 1120, which may involve a clamp at the pipette tip connector portion 103. The plunger 200 may be attached to the apparatus, specifically to the first and second plates 1121, 1122 by a plunger clamping mechanism 1140, which may involve a clamp at the plunger tip connector portion 203. One or more plates may comprise multiple clamping mechanisms 1120, 1140, to clamp multiple pipette tips 100 and plungers 200.

As regards the plunger clamping mechanism 1140, there may be provided an array of plunger clamping members 1147 each associated with one of a plurality of plunger mounts 1143. The array of plunger clamping members 1147 may be provided in the form of a plurality of clamping rods 1147 which extend axially from a first plate 1121 and extend into the bores defined within the plunger mount sleeves 1143. Each clamping rod 1147 may have an enlarged head 1148 at its lower end which extends from a narrower neck region 1149A. The enlarged head 1148 has an outer diameter which is less than the inner diameter of the plunger mount sleeve 1143. In this manner, a small clearance is provided between the outer surface of the enlarged head 1148 and the inner surface of the plunger mount sleeve 1143 when the plunger clamping mechanism is engaged. The neck 1149A has an outer diameter which is less than that of the enlarged head 1148. Preferably, each clamping rod 1147 also has a main shaft 1149B with an outer diameter which is substantially the same as the inner diameter of the region of the plunger mount sleeve 1143 in which it is located. The main shaft 1149B slides along the inner surface of the plunger mount 1143 as the first plate 1121 is moved up and down in the axial direction relative to the second plate 1122. This can help to ensure correct lateral alignment between the plunger mounts 1143 and the plunger clamping members 1147.

As regards the pipette tip clamping mechanism 1120, the tip connector portion 103 is configured for connection to a liquid handling system, for example with a snap-fit connection. The tip connector portion 103 may comprise a split tubular wall which may be defined by a plurality of flexible segments. The flexible segments may be configured to resiliently deflect in a radially outward direction to increase the outer diameter of the proximal end 101 of the pipette tip 100 from a first outer diameter, in which the flexible segments are undeflected and the tip connector portion is in a rest state, to a second outer diameter, in which the flexible segments are deflected radially outwardly and the tip connector portion is in an expanded state. In the embodiment depicted, the tip connector portion 103 comprises a plurality of axially extending discontinuities or slots in the tubular wall which separate a plurality of flexible segments. The plurality of slots may be 2, 3 or 4 slots, and the plurality of flexible segments may be 2, 3 or 4 segments. The tip connector portion 103 may comprise any suitable number of axially extending discontinuities to define any number of flexible segments. The arrangement of flexible segments and slots enables the tip connector portion to expand without requiring significant forces to be exerted on the tip connector portion. The tip connector portion 103 may further comprise one or more radially extending features 1126 on its inner surface by which the pipette tip may be coupled to the pipetting head. The radially extending feature on the inner surface of the tip connector portion 103 may comprise a protrusion, which extends radially inward, and/or a recess or groove, which extends radially outward. The radially extending feature may extend in a circumferential direction. In the depicted embodiment, the radially extending feature on the inner surface of the tip connector portion 103 comprises a part-annular rib 1126 which protrudes from the inner surface of the tip connector portion 103. Preferably, the second outer diameter to which the tip connector portion is increased is larger than the first outer diameter by at least the radial extent of the radially extending feature 1126.

The pipette tip 100 may be clamped between a tip mount sleeve 123 and a plate, such as the fourth plate 1124 as shown in FIG. 9. The tip mount sleeve 123 may be provided on a plate, such as the third plate 1123.

With reference to FIG. 9, one or more method steps may be carried out by one or more actuators 1161, 1162, 1163, which may be comprised in the liquid dispensing apparatus. The one or more actuators may be controlled by one or more controllers 1171.

The controller 1171 may comprise one or more of: a processor, a memory, one or more input ports, one or more output ports, and may comprise or be connected to a user input device.

The user input device may comprise a mouse or keyboard, a hand-held device or touchscreen, which may have a graphical user interface. There may be provided a display such as a graphical user interface, which may be configured to display outputs. The display may be configured for input of information, and present an option to select a method or mode of operation, and/or an option to activate the mode. The display may display information such as what mode the apparatus is operating in, and/or any variable or variables selected. The display may be configured to present information such as which information has been inputted.

The controller 1171 may be configured to receive an input, specifically data, via one or more input ports. This data may be indicative of which method or mode to operate, any operational parameters such as volume of sample liquid, number of samples, location of samples, aspirating or dispensing time, aspirating or dispensing speed, pre-sample and/or post-sample airgap volume.

The controller 1171, specifically the processor of the controller, may determine, based on one or more inputs, a signal or signals to send to the one or more actuators 1161, 1162, 1163, 1164. This determination may involve a set of instructions, which may be stored in memory. The controller 1171 may output signals to one or more actuators 1161, 1162, 1163, 1164 and/or to a conversion or switching means, such as an electrical relay.

The memory may comprise a computer readable storage medium such as a hard disk drive (HDD), flash drive, solid state drive, or any other form of general-purpose data storage, upon which information and various programs are arranged. Such programs may include, for example, one or more pre-programmed modes or methods of operation of the apparatus.

The apparatus may comprise one or more communication means which may provide a communication pathway between the controller 1171 via one or more input or output ports, and the one or more actuators 1161, 1162, 1163, 1164. The communication means may comprise a wire or cable, which may physically connect the controller 1171 to one or more actuators 1161, 1162, 1163, 1164. There may be a wire or cable to each actuator from the controller 1171, for example as indicated in FIG. 9. Alternatively or in addition, the communication means may comprise wireless connection, such as a transmitter and receiver.

There may be provided a first actuator 1161. The first actuator may be configured to move the pipette tip 100 relative to the plunger 200. This may allow the pipette to aspirate and/or dispense fluid. The first actuator 1161 may be configured to move the first and/or second plates 1121, 1122 relative to the third and/or fourth plates 1123, 1124. As represented in FIG. 9, the first actuator 1161 may move the second plate 1122 relative to the third plate 1123. The first actuator 1161 may be configured to receive a signal from the controller 1171 to cause movement of the plunger 200 and/or the second plate 1122 relative to pipette tip 100 and/or the third plate 1123 at a specific time and/or at a specific speed and/or by a specific amount and/or in a specific direction.

There may be provided a second actuator 1162. The second actuator 1162 may be configured to move the pipette tip 100 and/or plunger 200 relative to a fixed housing 1101. As represented in FIG. 9, the second actuator 1162 may move the third plate 1123 relative to a housing 1101. This allows the pipette tip 100 and/or plunger 200 to be moved relative to a sample receptacle. The second actuator 1162 may be configured to receive a signal from the controller 1171 to cause movement of the pipette tip 100 and/or plunger 200 and/or the third plate 1123 relative to a sample container, at a specific time and/or at a specific speed and/or by a specific amount and/or in a specific direction.

The apparatus may comprise a body with a receptacle receiving area, such as a microplate receiving area, or deck, and a pipetting head positioned above the microplate receiving area. The microplate receiving area may have a substantially horizontal upper surface arranged to receive a laboratory microplate. The receiving area can be located on a height-adjustable support structure which enables the height of the microplate receiving area to be varied as required. The receiving area may be configured to retain a laboratory microplate in a fixed position. For example, the upper surface of the receiving area may comprise one or more recesses arranged to receive a microplate and to prevent lateral translation of the microplate with respect to the receiving area. The pipetting head of the apparatus may be configured to hold an array of pipettes, and may be moveable in relation to a deck to bring pipettes mounted on the pipetting head into close proximity to a microplate supported on the deck to allow liquid to be aspirated from or dispensed into the wells of the microplate.

The second actuator 1162 may be configured to move the second and third plates 1122 and 1123 relative to the microplate receiving area. The fixed housing 1101 may be attached to the microplate receiving area.

There may be provided a third actuator 1163. The third actuator 1163 may be configured to, upon receipt of a signal from the controller 1171, attach and/or disconnect the plunger from the system. The third actuator may be connected to the first plate and second plate 1121, 1122, so as to move the first plate 1121 relative to the second plate 1122. The third actuator 1163 may be a rotary actuator, which may be configured to provide linear movement of the first plate 1121 relative to the second plate 1122.

There may be provided a fourth actuator 1164. The fourth actuator 1164 may be configured to, upon receipt of a signal from the controller 1171, attach and/or disconnect the pipette tip 100 from the system. The fourth actuator may be connected to the third plate and the fourth plate 1123, 1124. The fourth actuator 1164 may be a rotary actuator.

To perform an aspirating operation, the plunger 200 and pipette tip 100, or series of plungers and pipette tips, may be moved to the desired position relative to a liquid sample receptacle. The plunger 200, or plunger 200 of each pipette 10 may then be raised within its respective pipette tip 100, which may be done using the first actuator 1161, which may be a direct drive actuator to move plates 1121 and 1123 relative to one another in the direction of arrows 1161′. This may move the entire plunger clamping mechanism 1140, and the plunger plates 1121, 1122 away from the pipette tip clamping mechanism 1120 and the pipette tip plates 1123, 1124, as shown in FIG. 9, to draw fluid into the pipette tip 100. The fluid can then be dispensed as desired by moving the plunger clamping mechanism 1140 in the opposite direction using the direct drive actuator 1161.

The direct drive actuator 1161 may be operable to move the plunger clamping mechanism 1140 in an axial direction towards or away from a plate or plates of the pipette tip clamping mechanism 1120 to aspirate or dispense liquid during use. There may be provided a head chassis, and the direct drive actuator 1161 may be fixed in relation to the head chassis. The direct drive actuator 1161 may extend between the head chassis and the plunger clamping mechanism 1140.

The direct drive actuator 1161 may comprise an actuator motor, which may be mounted on the top surface of a head chassis and extends between the head chassis and the plunger. The output shaft of the actuator motor 1161 may be fixed to a threaded rod connected to a ball screw actuator nut. The nut may be fixed to a ball screw mount which in turn is fixed to a plunger clamp motor mount plate at the upper end of the plunger clamping mechanism 1140. The direct drive actuator 1161 thus may extend between the head chassis and the plunger clamping mechanism 1140. When the actuator motor 1161 is operated, the entire plunger clamping mechanism 1140 may be moved in the axial direction either towards or away from the pipette tip clamping mechanism 1120, to move the plunger in one axial direction or another relative to the pipette tip 100, depending on the direction of rotation of the actuator motor 1161. In this manner, the speed of relative movement between a plunger clamped by the plunger clamping mechanism 1140 and the pipette tip within which it extends can be varied to a much greater extent than with known devices. This allows the apparatus to be used in a non-contact dispensing mode as well as a contact dispensing mode. When performing non-contact dispensing, a liquid sample must be travelling at a high enough velocity to detach from the tip. Sufficient velocity for non-contact dispensing can be achieved with the direct drive actuator 1161, which in some instances cannot be achieved with a belt drive. Specifically, direct drive via a ball screw offers higher acceleration and deceleration of heavy loads than a belt driven system. This is particularly advantageous where the distance travelled for a dispense shot is small (for example, <1 mm), therefore high acceleration and deceleration allows the system to reach target velocity. In addition, ball screws offer higher positional accuracy and repeatability, which is has a beneficial effect on dispense performance.

The apparatus may be configured such that the controller 1171, specifically the memory and processor, causes the first actuator and the second actuator 1161, 1162 to carry out aspirating/dispensing steps.

For example, the controller 1171 may comprise a computer readable medium which comprises instructions that, when executed by the processor, cause the processor to send a signal to cause retraction of the plunger 200 within the pipette tip 100 so as to aspirate air to form a pre-sample air gap 300;
output a signal to cause insertion of the pipette tip 100 into a sample liquid;
output a signal to cause retraction of the plunger 200 within the pipette tip 100 so as to aspirate sample liquid; and
output a signal to cause withdrawal of the pipette tip 100 from the sample liquid. The computer readable medium may comprise instructions that, when executed by a processor, cause the processor to carry out any of the method steps noted herein.

The signal to cause insertion of the pipette tip 100 into a sample liquid may be sent to the second actuator 1162. The signal to cause retraction of the plunger 200 within the pipette tip 100 so as to aspirate sample liquid may be sent to the first actuator 1161. The signal to cause withdrawal of the pipette tip 100 from the sample liquid may be sent to the second actuator 1162.

The controller 1171 may comprise a computer readable medium, which comprises instructions that, when executed by the processor, cause the processor to send a signal to cause disconnection of the pipette tip 100 and/or plunger 200 from the apparatus. This signal may be sent to the third actuator 1163 and/or the fourth actuator 1164.

One, more or all actuators 1161, 1162, 1163, 1164 may be configured to cause movement in the same direction. When installed, one, more or all actuators 1161, 1162, 1163, 1164 may be configured to cause movement of the system in an axial direction which may be a vertical direction.

Although the invention has been described above with reference to one or more preferred embodiments, it will be appreciated that various changes or modifications may be made without departing from the scope of the invention as defined in the appended claims.

For example, a plunger and pipette tip arrangement have been described and shown in which each of the plunger and pipette tip have various portions. While these have been described in combination, the skilled person will appreciate that the advantages of the present disclosure may be achieved with any suitable combination or permutation or pipette tip or plunger portions.

While the term “airgap” has been used herein, the skilled person will appreciate that there are various suitable gases that could be used in such a method, and that “airgap” should not be limited to only air. The airgap may comprise atmospheric gas, or a gas of controlled composition.

While the term “plunger” has been used herein, the skilled person will appreciate that the term “piston” may also describe the plunger.

The term “diameter” has been used as a dimensional parameter. The skilled person will appreciate that the invention may be realised without requiring a strictly cylindrical or circular shape. As such, the term diameter may be read as lateral dimension. Embodiments involving cylindrical or circular shapes (and as such components for which the term “diameter” is particularly suitable) may be advantageous.

Where the word ‘or’ appears, this may be construed to mean ‘and/or’ such that items referred to are not necessarily mutually exclusive and may be used in any appropriate combination.

What is claimed is:

1. A pipette for aspirating and/or dispensing liquids, comprising:
a pipette tip, having:
a proximal end and a distal end and a longitudinal axis extending therebetween;
an aperture at the distal end,
a fluid cavity extending from the aperture at least partially towards the proximal end;
the pipette tip comprising an end portion disposed at the distal end, having an inner wall surface extending at an angle of between 2 degrees and 5 degrees relative to the longitudinal axis, for at least 5 mm; and
a plunger positioned inside the pipette tip, configured to extend at least partly between the proximal and distal ends of the pipette tip into the end portion, and movable towards and away from the aperture to aspirate or dispense fluid from the pipette tip.

2. The pipette of claim 1, wherein the end portion has an outer wall surface extending at an angle of at most 5 degrees relative to the longitudinal axis, for at least 5 mm.

3. The pipette of claim 1, wherein the aperture has a diameter of at most 1 mm.

4. The pipette of claim 1, wherein the end portion has a maximum outer diameter of at most 4 mm.

5. The pipette of claim 1, wherein the inner wall surface of the end portion of the pipette tip defines a straight-sided shape, such as a frusto-conical or cylindrical shape.

6. The pipette of claim 1, wherein the outer wall surface of the end portion of the pipette tip defines a straight-sided shape, such as a frusto-conical or cylindrical shape.

7. The pipette of claim 1, wherein the plunger has an end portion outer wall surface configured for alignment with the inner wall surface of the pipette tip end portion.

8. The pipette of claim 1, wherein the plunger is configured to seal the aperture when in an extended position.

9. The pipette of claim 1, wherein the plunger has a plunger end portion which substantially fills the end portion of the pipette tip when in an extended position.

10. The pipette of claim 1, wherein the plunger has a plunger end portion which does not substantially fill the end portion of the pipette tip when in an extended position.

11. The pipette of claim 1, wherein the inner wall surface extends at an angle of at most 4 degrees relative to the longitudinal axis.

12. The pipette of claim 1, wherein the inner wall surface of the end portion extends for at least 7 mm.

13. A liquid handling system comprising:
the pipette of claim 1;
and an actuator configured to move the plunger relative to the pipette tip.

14. A liquid handling system comprising:
a plurality of pipettes according to claim 1;
and an actuator configured to move multiple pipette tips and/or plungers of the plurality of pipettes so as to aspirate and/or dispense a fluid.

15. The liquid handling system of claim 14, wherein the actuator is configured to move multiple pipette tips and/or plungers of the plurality of pipettes simultaneously so as to aspirate and/or dispense a fluid.

16. The liquid handling system of claim 14, wherein the plurality of pipette tips is at least 10.
